(19) United States
(12) Patent Application Publication
(10) Pub. No.: US 2010/0262294 A1
(43) Pub. Date: Oct. 14, 2010

(54) APPARATUS AND METHOD FOR CONTROLLING SCREEN

(75) Inventors: JING-ZHOU LAI, Shenzhen City (CN); ZUO-QIU CHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/755,424

(22) Filed: Apr. 7, 2010

(30) Foreign Application Priority Data
Apr. 8, 2009 (CN) 200910301420.2

(51) Int. Cl. G05B 15/02; G06K 9/00

(52) U.S. Cl. 700/275; 382/103

(57) ABSTRACT

An apparatus and a method for controlling a screen are disclosed herein, the apparatus includes an object detection module and an adjusting device. The object detection module can detect a position of at least one object. A position analyzer recognizes the position of the object and the adjusting device can set the screen to a predetermined position according to the result recognized by the position analyzer.

### BACKGROUND

1. Technical Field

The present disclosure relates to an apparatus and method for controlling a screen, and more particularly to an apparatus and a method for controlling the screen after detecting an object.

2. Description of Related Art

Display devices in modern monitors can be a thin film transistor liquid crystal display (TFT-LCD).

A user viewing the such a display device may change his/her position relative to the display device for one or more reasons. If the user changes his/her posture, the user may have to manually adjust the position of a screen of the display according to a desired angle of vision.

In view of the above, it is necessary to provide a system and method to adjust the position of the screen automatically.

### SUMMARY

In one aspect, the present disclosure is directed to an apparatus for controlling a screen, so as to adjust the position of the screen based on the position of the face.

According to one embodiment of the present disclosure, the apparatus includes an object detection module and an adjusting device. The object detection module can detect a position of at least one object. The adjusting device can set the screen to a predetermined position.

In another aspect, the present disclosure is directed to a method for controlling a screen, so as to adjust the position of the screen based on the position of the face.

According to another embodiment of the present disclosure, the method includes steps as follows: (a) a position of at least one object is detected; (b) the screen is set to a predetermined position.

The foresaid and other problems are generally reduced, solved or circumvented, and technical advantages are generally achieved, by embodiments of the present disclosure. One of the advantageous features of the present disclosure is that the position of the screen is adjusted automatically; thus, the user can watch the screen with a desired angle of vision.

### BRIEF DESCRIPTION OF THE DRAWINGS

FIG. 1 is a block diagram of an apparatus for controlling a screen according to an embodiment of the present disclosure.

FIG. 2A is a lateral view of the vertical moving device and the screen of FIG. 1.

FIG. 2B is a lateral view of the vertical rotation device and the screen of FIG. 1.

FIG. 2C is a lateral view of the horizontal rotation device and the screen of FIG. 1.

FIG. 3 is a schematic diagram of one embodiment of a method for controlling a screen according to another embodiment of the present disclosure.

FIG. 4 is a flowchart of one embodiment of the method of FIG. 3.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

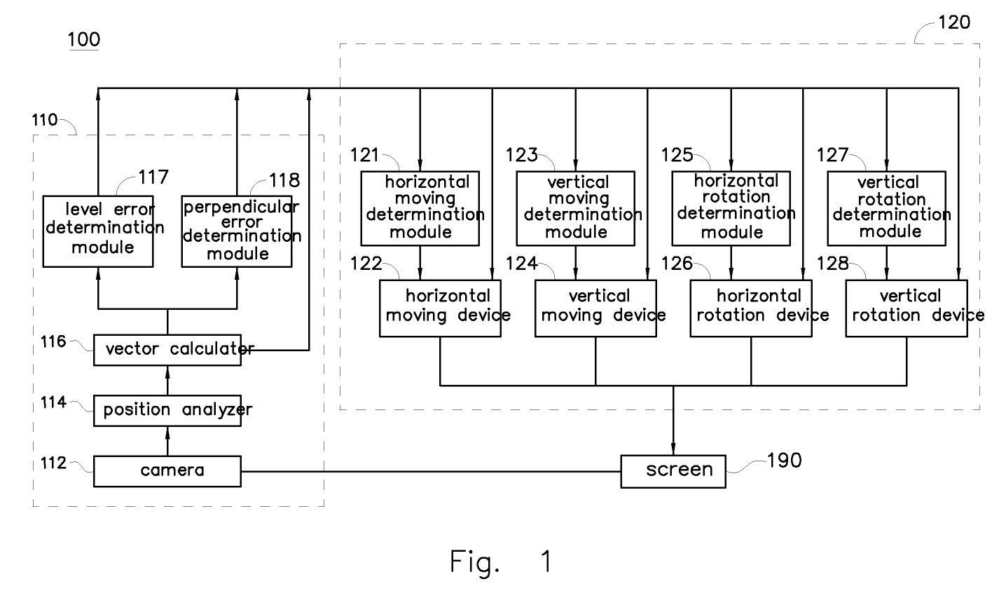

In one or more aspects, the present disclosure is directed to an apparatus 100 for controlling a screen. The apparatus 100 may be easily inserted into existing devices and may be applicable or readily adaptable to all technology. FIG. 1 is presented to illustrate the block diagram of the apparatus 100.

As shown in FIG. 1, the apparatus 100 includes an object detection module 110 and an adjusting device 120. The object detection module 110 can detect a position of at least one object. The adjusting device 120 can set a screen 190 to a predetermined position. Thus, the user can watch the screen with a desired angle of vision. The object comprises a face of a human. The adjusting device 120 adjusts the screen 190 to face directly to the face.

The object detection module 110 may comprises a camera 112, a position analyzer 114, a vector calculator 116, a horizontal error determination module 117 and a vertical error determination module 118. If the object is a face of a human, the camera 112 can capture at least one frame of the face, where the frame comprises an image of the face. The position analyzer 114 can recognize the face image in the frame and analyze a position of the face image relative to a center of the frame. The vector calculator 116 can calculate a horizontal distance in a horizontal direction from the center of the frame to a center of the face image along a horizontal axis according to the position of the face image relative to the center of the frame and also calculate a vertical distance in a vertical direction from the center of the frame to the center of the face image along a vertical axis according to the position of the face image relative to the center of the frame. The horizontal error determination module 117 can determine whether the horizontal distance is greater than a predetermined horizontal error range. The vertical error determination module 118 can determine whether the vertical distance is greater than a predetermined vertical error range.

The relative position between the camera 112 and the screen 190 may be kept constant, for example, the camera 112 and the screen 190 can be integrated into a display. In use, the camera 112 can capture the frame with the face image from the face, where the center of the frame essentially corresponds to the center of the screen 190.

The position analyzer 114 may comprises a face recognition system, such as AdaBoost. In the face recognition system, AdaBoost classifiers can define the input image as face images and non-face images. In this way, the non-face images are excluded from the input image. For increasing the accuracy of the face recognition and reducing processing resources of a CPU, in the frame captured by camera 112, the background is erased beforehand, so that the face recognition system can receive the frame without the background as the input image. Accordingly, the position analyzer 114 can recognize the face image in the frame and analyze a position of the face image relative to a center of the frame.

The vector calculator 116 can calculate a vector form the center of the frame to the center of the face image. The vector comprises the horizontal distance in the horizontal direction from the center of the frame to the center of the face image along the horizontal axis and the vertical distance in the vertical direction from the center of the frame to the center of the face image along the vertical axis. The horizontal distance represents the relative position between the center of the screen 190 and the center of the face along the horizontal axis but is not limited to be a horizontal distance absolutely; the vertical distance represents the relative position between the center of the screen 190 and the center of the face along the vertical axis but is not limited to be a scaled vertical distance absolutely.

In one embodiment, the center of the face can be defined as the nose of a person. If the center of the screen 190 does not face the nose and faces another portion of the face, such as a eye, a eyebrow, a mouth or the like, this deviation does not affect the user's angle of view to watch the screen In one or more embodiments, the predetermined level error range represents a horizontal length between one eye and the nose. The predetermined perpendicular error range represents a vertical length between one eye and the nose. When the center of the screen 190 faces an area within the predetermined horizontal and vertical error ranges, the adjusting device 120 may not have to adjust the position of the screen 190. Alternatively or additionally, those with ordinary skill in the art may adjust the predetermined horizontal error range and the predetermined vertical error range depending on the desired application.

The adjusting device 120 may comprises a horizontal moving device 122 and a vertical moving device 124. When the level error determination module 117 determines that the horizontal distance is greater than the predetermined level error range, the horizontal moving device 122 can gradually move the screen 190 in the horizontal direction, wherein the screen 190 is moved by one horizontal moving scale each time. When the perpendicular error determination module 118 determines that the vertical distance is greater than the predetermined perpendicular error range, the vertical moving device 124 can gradually move the screen 190 in the vertical direction and the screen 190 is moved by one vertical moving scale each time. In this way, the adjusting device 120 can gradually adjust the position of the screen 190, so that the center of the screen 190 is gradually adjusted toward the face. It should be appreciated that foresaid “one” vertical moving scale is only an example. Those with ordinary skill in the art may choose a plurality of the vertical moving scales depending on the desired application.

Whenever the horizontal moving device 122 moves the screen 190 by one horizontal moving scale, the vector calculator 116 can calculate the horizontal distance in the horizontal direction from the center of the frame to the center of the face image anew. Then, the level error determination module 117 can determine whether the horizontal distance is greater than the predetermined level error range. When the horizontal distance is less than or equal to the predetermined level error range, the horizontal moving device 122 can stop moving the screen 190 in the horizontal direction. When the horizontal distance is greater than the predetermined level error range, the horizontal moving device 122 can gradually move the screen 190 in the horizontal direction, where the screen 190 is moved by the horizontal moving scale each time.

Whenever the vertical moving device 124 moves the screen 190 by one vertical moving scale, the vector calculator 116 can calculate the vertical distance in the vertical direction from the center of the frame to the center of the face image anew. Then, the perpendicular error determination module 118 can determine whether the vertical distance is greater than the predetermined perpendicular error range. When the vertical distance is less than or equal to the predetermined perpendicular error range, the vertical moving device 124 can stop moving the screen 190 in the vertical direction. When the vertical distance is greater than the predetermined perpendicular error range, the vertical moving device 124 can proceed to gradually move the screen 190 in the vertical direction, wherein each time the screen 190 is moved by the vertical moving scale.

The horizontal moving scale may be only one percentage of a movable range in the horizontal axis, wherein the horizontal moving device 122 is capable of moving the screen 190 within the movable range. For example, the horizontal moving device 122 can move the screen 190 from the leftest position (0%) to the most right position (100%). The vertical moving scale may be one percentage of a movable range in the vertical axis, wherein the vertical moving device 124 is capable of moving the screen 190 within the movable range. For example, the vertical moving device 124 can move the screen 190 from the highest position (0%) to the lowest position (100%). It should be appreciated that said one percentage of the movable range is only an example and should not be regarded as a limitation of the present disclosure. Those with ordinary skill in the art may adjust the horizontal moving scale and the vertical moving scale depending on the desired application.

The adjusting device 120 may comprises a horizontal moving determination module 121 and a vertical moving determination module 123. The horizontal moving determination module 121 can determine whether the horizontal moving device 122 is capable of moving the screen 190 in the horizontal direction. When the horizontal moving device 122 is capable of moving the screen 190 in the horizontal direction, the horizontal moving determination module 121 can command the horizontal moving device 122 to move the screen 190 in the horizontal direction. When the horizontal moving device 122 is incapable of moving the screen 190 in the horizontal direction, such as the screen 190 at the leftest position (0%) or the most right position (100%) within the movable range, the horizontal moving determination module 121 can command that the horizontal moving device 122 stops moving the screen 190 in the horizontal direction.

The vertical moving determination module 123 can determine whether the vertical moving device 124 is capable of moving the screen 190 in the vertical direction.

When the vertical moving device 124 is capable of moving the screen 190 in the vertical direction, the vertical moving determination module 123 can command that the vertical moving device 124 moves the screen 190 in the vertical direction. When the vertical moving device 124 is incapable of moving the screen 190 in the vertical direction, such as the screen 190 at the highest position (0%) or the lowest position (100%) within the movable range, the vertical moving determination module 123 can command that the vertical moving device 124 stops moving the screen 190 in the vertical direction.

The adjusting device 120 may comprises a horizontal rotation device 126 and a vertical rotation device 128. When the level error determination module 117 determines that the horizontal distance is greater than the predetermined level error range, the horizontal rotation device 126 can gradually rotate the screen 190 in the horizontal direction, wherein each time the screen 190 is rotated by a horizontal rotating scale. When the perpendicular error determination module 118 determines that the vertical distance is greater than the predetermined perpendicular error range, the vertical rotation device 128 can gradually rotate the screen 190 in the vertical direction when the vertical distance is greater than the predetermined perpendicular error range, wherein the screen 190 is rotated by a vertical rotating scale each time. In this way, the adjusting device 120 can gradually adjust the position of the screen 190, so that the center of the screen 190 is gradually adjusted toward the face.

Whenever the horizontal rotation device 126 rotates the screen 190 by the horizontal rotating scale, the vector calculator 116 can calculate the horizontal distance in the horizontal direction from the center of the frame to the center of the face image anew. Then, the level error determination module 117 can determine whether the horizontal distance is greater than the predetermined level error range. When the horizontal distance is less than or equal to the predetermined level error range, the horizontal rotation device 126 can stop rotating the screen 190 in the horizontal direction. When the horizontal distance is greater than the predetermined level error range, the horizontal rotation device 126 can proceed to gradually rotate the screen 190 in the horizontal direction, wherein the screen 190 is rotated by the horizontal rotating scale each time.

Whenever the vertical rotation device 128 rotates the screen 190 by the vertical rotating scale, the vector calculator 116 can calculate the vertical distance in the vertical direction from the center of the frame to the center of the face image anew. Then, the perpendicular error determination module 118 can determine whether the vertical distance is greater than the predetermined perpendicular error range. When the vertical distance is less than or equal to the predetermined perpendicular error range, the vertical rotation device 128 can stop rotating the screen 190 in the vertical direction. When the vertical distance is greater than the predetermined perpendicular error range, the vertical rotation device 128 can proceed to gradually rotate the screen 190 in the vertical direction, wherein the vertical rotating scale each time rotates the screen 190.

The horizontal rotating scale may be one percentage of a rotatable range in the horizontal axis, wherein the horizontal rotation device 126 is capable of rotating the screen 190 within the rotatable range. For example, the horizontal rotation device 126 can rotate the screen 190 from the leftest position (0%) to the most right position (100%). The vertical rotating scale may be one percentage of a rotatable range in the vertical axis, wherein the vertical rotation device 128 is capable of rotating the screen 190 within the rotatable range. For example, the vertical rotation device 128 can rotate the screen 190 from the highest position (0%) to the lowest position (100%). It should be appreciated that said one percentage of the rotatable range is only an example and should not be regarded as a limitation of the present disclosure. Those with ordinary skill in the art may adjust the horizontal rotating scale and the vertical rotating scale depending on the desired application.

The adjusting device 120 may comprises a horizontal rotating determination module 125 and a vertical rotating determination module 127. The horizontal rotating determination module 125 can determine whether the horizontal rotation device 126 is capable of rotating the screen 190 in the horizontal direction. When the horizontal rotation device 126 is capable of rotating the screen 190 in the horizontal direction, the horizontal rotating determination module 125 can command that the horizontal rotation device 126 rotates the screen 190 in the horizontal direction. When the horizontal rotation device 126 is incapable of rotating the screen 190 in the horizontal direction, such as the screen 190 at one margin angle (0%) or the other margin angle (100%) within the rotatable range, the horizontal rotating determination module 125 can command that the horizontal rotation device 126 stops rotating the screen 190 in the horizontal direction.

The vertical rotating determination module 127 can determine whether the vertical rotation device 128 is capable of rotating the screen 190 in the vertical direction. When the vertical rotation device 128 is capable of rotating the screen 190 in the vertical direction, the vertical rotating determination module 127 can command the vertical rotation device 128 to rotate the screen 190 in the vertical direction. When the vertical rotation device 128 is incapable of rotating the screen 190 in the vertical direction, such as the screen 190 at one margin angle (0%) or the other margin angle (100%) within the rotatable range, the vertical rotating determination module 127 can command that the vertical rotation device 128 stops rotating the screen 190 in the vertical direction.

In one embodiment, the position analyzer 114, the vector calculator 116, the level error determination module 117 and the perpendicular error determination module 118 can be software programs installed in a computer. The camera 112 may be a web cam that is positioned on screen 190 and is electrically connected to the computer via Universal Serial Bus. The adjusting device 120 and the screen 190 can be integrated into a display. The adjusting device 120 can be composed of a firmware and a motion device, such as a step motor or a gearing system.

In use, the camera 112 can capture the frame of the face, and the position analyzer 114 can receive the frame for tracking the face. The vector calculator 116, the level error determination module 117 and the perpendicular error determination module 118 can calculate the movement for the screen 190. Moreover, the vector calculator 116, the level error determination module 117 and the perpendicular error determination module 118 can calculate relevant parameters on the basis of the position of the face image relative to the center of the frame. Then the vector calculator 116, the level error determination module 117 and the perpendicular error determination module 118 can generate instruction based on the predetermined format and send the instruction to the display. In the adjusting device 120 of the display, the firmware controls the motion device, so as to maintain the screen 190 facing the face.

The display's firmware responds to the interrupt process of the microprocessor for sending and receiving I²C data. Once the interruption corresponding to I²C is triggered, the command is transformed into data based on I²C. After received the I²C data, the master program utilizes a command handler processes the I²C data. As to processing the I²C data, the main function includes three steps: (a) determining whether the instruction is effective, (b) explaining the instruction, and (c) executing the instruction. The step (a) is to determine whether the instruction corresponds to the explanation of the firmware and whether the firmware responds to the instruction. Furthermore, the step (a) is to check and correct the instruction's parameters. The step (b) is to process and transform the instruction into a corresponding code segment. The step (c) is to perform the content of the instruction for moving and/or rotating the screen 190.

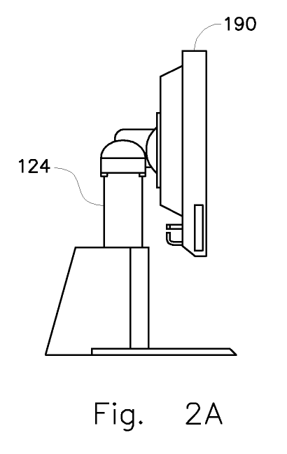

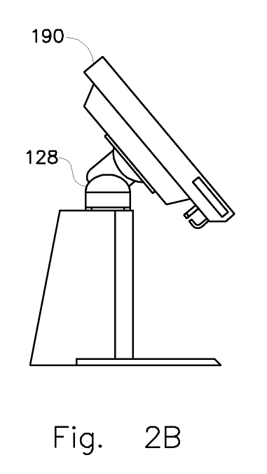

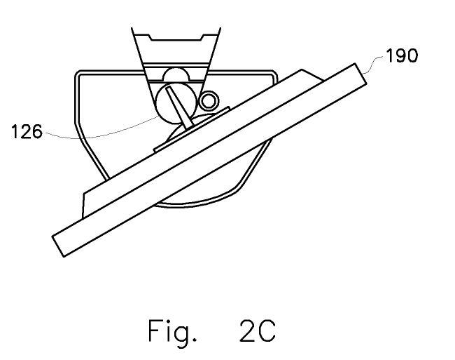

FIG. 2A is a lateral view of the vertical moving device 124 and the screen 190 of FIG. 1. As shown in FIG. 2A, the vertical moving device 124 is a telescopic electromechanical device that can move the screen 190 up and down along the vertical axis. Moreover, the horizontal moving device 122 (not shown in FIG. 2A) is another telescopic electromechanical device that is essentially the same as the structure of the vertical moving device 124 and moves the screen 190 left and right along the horizontal axis.

FIG. 2B is a lateral view of the vertical rotation device 128 and the screen 190 of FIG. 1. In use, the vertical rotation device 128 can adjust the orientation angle of the screen 190 up and down. FIG. 2C is a lateral view of the horizontal rotation device 126 and the screen 190 of FIG. 1. In use, the horizontal rotation device 126 can adjust the orientation angle of the screen 190 left and right.

In the above figures, it should be readily apparent to those skilled in the art that the present disclosure introduces an apparatus for controlling a screen. In use, one of the advantageous features of the apparatus is that the position of the screen is adjusted automatically; thus, the user can watch the screen with a desired angle of vision.

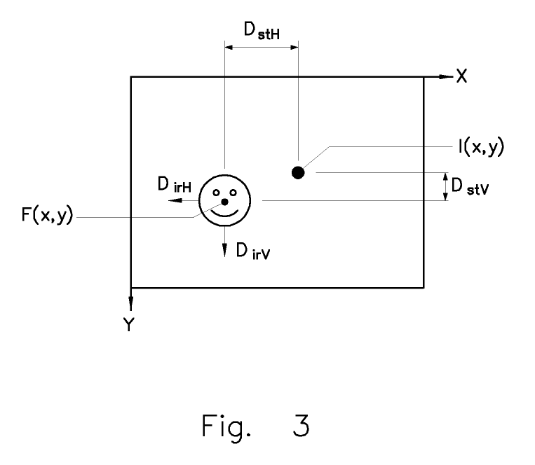

In another or more aspects, the present disclosure is directed to a method for controlling a screen. The method may be easily executed by existing devices. FIG. 3 is presented to illustrate the schematic diagram of the method for controlling the screen.

In this embodiment, it is not necessary to calculate a movement distance and a rotation angle for the screen. In the method, a direction of movement is calculated, and the center of the screen is gradually adjusted toward the face through “detection—fine adjustment” in an iterative manner.

The method for controlling the screen comprises steps (1)-(5) is shown as follows:

(1) At least one frame is captured from the face, wherein the frame comprises a face image; the face image in the frame is recognized. A position of the face image relative to a center of the frame is analyzed.

(2) A horizontal distance D_{stH} in a horizontal direction D_{irH} from the center I(x,y) of the frame to a center F(x,y) of the face image along a horizontal axis X is calculated according to the position of the face image relative to the center of the frame. A vertical distance D_{stV} in a vertical direction D_{irV} from the center I(x,y) of the frame to the center F(x,y) of the face image along a vertical axis Y is calculated according to the position of the face image relative to the center of the frame.

(3) When the horizontal distance D_{stH} is greater than a predetermined level error range, the step (4) is performed. When the horizontal distance D_{stH} is less than or equal to a predetermined level error range, the step (1) is repeated. When the vertical distance D_{stV} is greater than a predetermined perpendicular error range, the step (4) is performed. When the vertical distance D_{stV} is less than or equal to a predetermined perpendicular error range, the step (1) is repeated.

(4) When the screen can be moved in the horizontal direction D_{irH}, and when the horizontal distance D_{stH} is greater than the predetermined level error range, the screen is gradually moved in the horizontal direction D_{irH} wherein the screen is moved by one horizontal moving scale each time. Whenever the screen is moved by one horizontal moving scale, the steps (1)-(2) are performed anew to calculate the horizontal distance D_{stH} in the horizontal direction D_{irH} from the center I(x,y) of the frame to the center F(x,y) of the face image along the horizontal axis X. When the screen cannot be moved in the horizontal direction D_{irH}, the step (5) is performed. Additionally, when the screen can be moved in the vertical direction D_{irV}, and when the vertical distance D_{stV} is greater than the predetermined perpendicular error range, the screen is gradually moved in the vertical direction D_{irV}, wherein the screen is moved by one vertical moving scale each time. Whenever the screen is moved by one vertical moving scale, the steps (1)-(2) are performed anew to calculate the vertical distance D_{stV} in the vertical direction D_{irV} from the center I(x,y) of the frame to the center F(x,y) of the face image along the vertical axis Y. When the screen cannot be moved in the vertical direction D_{irV}, the step (5) is performed.

(5) Whether the screen can be rotated in the horizontal direction DirH is determined; when the screen can be rotated in the horizontal direction DirH, the screen is gradually rotated in the horizontal direction DirH when the horizontal distance DstH is greater than the predetermined level error range, wherein the screen is rotated by one horizontal rotating scale each time. Whenever the screen is rotated by one horizontal rotating scale, the steps (1)-(2) are performed anew to calculate the horizontal distance DstH in the horizontal direction DirH from the center I(x,y) of the frame to the center F(x,y) of the face image along the horizontal axis X. Additionally, whether the screen can be rotated in the vertical direction DirV is determined; when the screen can be rotated in the vertical direction DirV, the screen is gradually rotated in the vertical direction DirV when the vertical distance DstV is greater than the predetermined perpendicular error range, wherein each time the screen is rotated by one vertical rotating scale. Whenever the screen is rotated by one vertical rotating scale, the steps (1)-(2) are performed anew to calculate the vertical distance DstV in the vertical direction DirV from the center I(x,y) of the frame to the center F(x,y) of the face image along the vertical axis Y.

The sequence of the above steps is interchangeable but is not a limitation of the claim scope, and all or part of the steps may be simultaneously, partially simultaneously, or sequentially performed.

In the method, whether the screen can be moved or rotated along the horizontal axis X or the vertical axis Y is determined according to the present position of the screen and the movable and rotatable ranges.

If the horizontal direction towards the left was calculated, and if the screen was positioned at the leftest position (0%), the screen cannot be moved leftward; on the contrary, if the horizontal direction towards the left was calculated, and if the screen was not positioned at the leftest position (0%), the screen can be moved leftward Also, if the horizontal direction towards the right was calculated, and if the screen was positioned at the most right position (100%), the screen cannot be moved rightward; on the contrary, if the horizontal direction towards the right was calculated, and if the screen was not positioned at the most right position (100%), the screen can be moved rightward.

If the vertical direction was up, and if the screen was positioned at the highest position (0%), the screen cannot be moved upward; on the contrary, if the horizontal direction was up, and if the screen was not positioned at the highest position (0%), the screen can be moved upward Also, if the horizontal direction was down, and if the screen was positioned at the lowest position (100%), the screen cannot be moved downward; on the contrary, if the horizontal direction towards the right was calculated, and if the screen was not positioned at the lowest position (100%), the screen can be moved rightward.

If the horizontal direction towards the left was calculated, and if the screen was positioned at a margin angle (0%), the screen cannot be rotated leftward; on the contrary, if the horizontal direction towards the left was calculated, and if the screen was not positioned at the margin angle (0%), the screen can be rotated leftward. If the horizontal direction towards the right was calculated, and if the screen was positioned at another margin angle (100%), the screen cannot be rotated rightward; on the contrary, if the horizontal direction towards the right was calculated, and if the screen was not positioned at said another margin angle (100%), the screen can be rotated rightward.

If the vertical direction was up, but the screen was positioned at a margin angle (0%), the screen cannot be rotated upward; on the contrary, if the horizontal direction was up, and if the screen was not positioned at the margin angle (0%), the screen can be rotated upward if the horizontal direction was down, but the screen was positioned at another margin angle (100%), the screen cannot be rotated downward; on the contrary, if the horizontal direction towards the right was calculated, and if the screen was not positioned at said another margin angle (100%), the screen can be rotated rightward.

When a plurality of face images in the same frame are recognized in this method, a final center position of the face images is calculated according to the positions of the face images, where the distances from the final center position to each the face images are essentially the same. Furthermore, the movement for the screen, such as translational motion, a vertical rotating angle and a horizontal rotating angle, is calculated on the basis of the final center position of the face images, the center of the frame and relevant parameters, such as moving scales, rotating scales and speed.

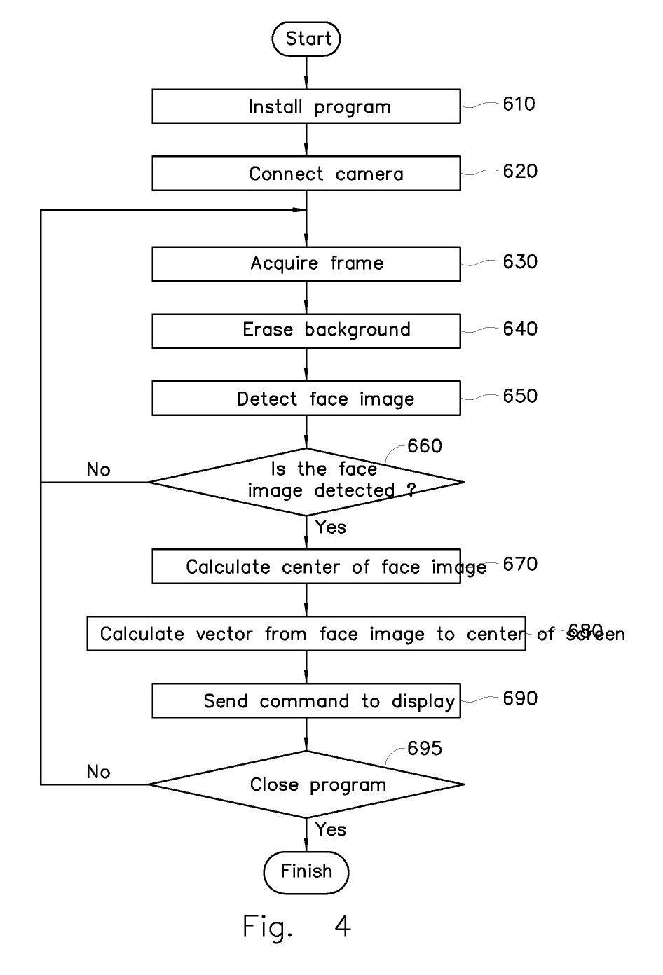

FIG. 4 is a flowchart of the method of FIG. 3. The method comprises steps 610-695 are shown as follows:

First, a software program of the face recognition system is installed in the computer in step 610. Then, the camera is connected to the computer in step 620. Then, the frame is captured through the camera in step 630. Then, the background of the frame is erased in step 640. Then, the software is executed to recognize the face image in the frame in step 650. Then, whether the face image is detected is determined in step 660. When the face image is not detected, the step 630 is performed anew. When the face image is detected, the position of the face image in the frame is calculated in step 670. Then, the vector from the screen the center to the face image is calculated in step 680. Then, a command is sent to the display in step 690. Accordingly, the screen of the display is gradually toward the user's face and then faces the user's face. Last, the software program of the face recognition system is closed in step 695.

The steps are not recited in the sequence in which the steps are performed. That is, unless the sequence of the steps is expressly indicated, the sequence of the steps is interchangeable, and all or part of the steps may be simultaneously, partially simultaneously, or sequentially performed. The implements to perform the method disclosed in above embodiments, thus, are not repeated herein.

In view of all of the above and the Figures, it should be readily apparent to those skilled in the art that the present disclosure introduces a method for controlling a screen. In use, one of the advantageous features of the method is that the position of the screen is adjusted automatically; thus, the user can watch the screen with a desired angle of vision.

The reader's attention is directed to all papers and documents which are filed concurrently with his specification and which are open to public inspection with this specification, and the contents of all such papers and documents are incorporated herein by reference.

It will be understood that the above description of embodiments is given by way of example only and that those with ordinary skill in the art may make various modifications. The above specification, examples and data provide a complete description of the structure and use of exemplary embodiments of the disclosure. Although various embodiments of the disclosure have been described above with a certain degree of particularity, or with reference to one or more individual embodiments, those with ordinary skill in the art could make numerous alterations to the disclosed embodiments without departing from the spirit or scope of this disclosure.

1. An apparatus for controlling a screen, the apparatus comprising:
an object detection module for detecting a position of at least one object;
a position analyzer for recognizing the position of the at least one object; and
an adjusting device for setting the screen to a predetermined position after the position analyzer has recognized the position.

2. The apparatus of claim 2, wherein the object comprises a face of a human.

3. The apparatus of claim 2, wherein the adjusting device adjusts the screen to face directly to the face of the human.

4. The apparatus of claim 2, wherein the object detection module comprises:
a camera for capturing at least one frame of the face of the human, wherein the frame comprises a face image; and
the position analyzer further comprising a function for analyzing a position of the face image relative to a center of the frame.

5. The apparatus of claim 4, wherein the object detection module further comprises:
a vector calculator for calculating a horizontal distance in a horizontal direction from the center of the frame to a center of the face image along a horizontal axis according to the position of the face image relative to the center of the frame, and calculating a vertical distance in a vertical direction from the center of the frame to the center of the face image along a vertical axis according to the position of the face image relative to the center of the frame.

6. The apparatus of claim 5, wherein the object detection module further comprises:
a horizontal error determination module for determining whether the horizontal distance is greater than a predetermined level error range; and
a vertical error determination module for determining whether the vertical distance is greater than a predetermined perpendicular error range.

7. The apparatus of claim 6, wherein the adjusting device comprises:
a horizontal moving device for gradually moving the screen in the horizontal direction when the horizontal distance is greater than the predetermined level error range, wherein the screen is moved by one horizontal moving scale each time; and
a vertical moving device for gradually moving the screen in the vertical direction when the vertical distance is greater than the predetermined perpendicular error range, wherein the screen is moved by one vertical moving scale each time.

8. The apparatus of claim 7, wherein the horizontal moving device stops moving the screen in the horizontal direction when the horizontal distance is less than or equal to the predetermined level error range.

9. The apparatus of claim 7, wherein the vertical moving device stops moving the screen in the vertical direction when the vertical distance is less than or equal to the predetermined perpendicular error range.

10. The apparatus of claim 7, wherein the adjusting device further comprises:
a horizontal moving determination module for determining whether the horizontal moving device is capable of moving the screen in the horizontal direction, wherein when the horizontal moving device is capable of moving the screen in the horizontal direction, the horizontal moving determination module commands that the horizontal moving device moves the screen in the horizontal direction; and
a vertical moving determination module for determining whether the vertical moving device is capable of moving the screen in the vertical direction, wherein when the vertical moving device is capable of moving the screen in the vertical direction, the vertical moving determination module commands that the vertical moving device moves the screen in the vertical direction.

11. The apparatus of claim 6, wherein the adjusting device comprises:
a horizontal rotation device for gradually rotating the screen in the horizontal direction when the horizontal distance is greater than the predetermined level error range, wherein the screen is rotated by one horizontal rotating scale each time; and
a vertical rotation device for gradually rotating the screen in the vertical direction when the vertical distance is greater than the predetermined perpendicular error range, wherein the screen is rotated by one vertical rotating scale each time.

12. The apparatus of claim 11, wherein the horizontal rotation device stops rotating the screen in the horizontal direction when the horizontal distance is less than or equal to the predetermined level error range.

13. The apparatus of claim 11, wherein the vertical rotation device stops rotating the screen in the vertical direction when the vertical distance is less than or equal to the predetermined perpendicular error range.

14. The apparatus of claim 11, wherein the adjusting device further comprises:
a horizontal rotation determination module for determining whether the horizontal rotation device is capable of rotating the screen in the horizontal direction, wherein when the horizontal rotation device is capable of rotating the screen in the horizontal direction, the horizontal rotation determination module commands that the horizontal rotation device rotates the screen in the horizontal direction; and
a vertical rotation determination module for determining whether the vertical rotation device is capable of rotating the screen in the vertical direction, wherein when the vertical rotation device is capable of rotating the screen in the vertical direction, the vertical rotation determination module commands that the vertical rotation device rotates the screen in the vertical direction.

15. A method for controlling a screen, the method comprising:
(a) detecting a position of at least one object;
(b) recognizing the position of the at least one object; and
(c) setting the screen to a predetermined position after recognition of the position.

16. The method of claim 15, wherein step (a) comprises detecting a position of at least one face of a human.

17. The method of claim 16, wherein the step (b) comprises adjusting the screen to face directly to the face of the human.

18. The method of claim 16, wherein the step (a) comprises:
capturing at least one frame of the face, wherein the frame comprises a face image;
recognizing the face image in the frame; and
analyzing a position of the face image relative to a center of the frame.

19. The method of claim 18, wherein the step (a) further comprises:
calculating a horizontal distance in a horizontal direction from the center of the frame to a center of the face image along a horizontal axis according to the position of the face image relative to the center of the frame; and
calculating a vertical distance in a vertical direction from the center of the frame to the center of the face image along a vertical axis according to the position of the face image relative to the center of the frame.

20. The method of claim 19, wherein the step (a) further comprises:
determining whether the horizontal distance is greater than a predetermined level error range; and
determining whether the vertical distance is greater than a predetermined perpendicular error range.

21. The method of claim 20, wherein the step (b) comprises:
gradually moving the screen in the horizontal direction when the horizontal distance is greater than the predetermined level error range, wherein the screen is moved by one horizontal moving scale each time; and
gradually moving the screen in the vertical direction when the vertical distance is greater than the predetermined perpendicular error range, wherein the screen is moved by one vertical moving scale each time.

22. The method of claim 20, further comprising:
stopping moving the screen in the horizontal direction when the horizontal distance is less than or equal to the predetermined level error range.

23. The method of claim 20, further comprising:
stopping moving the screen in the vertical direction when the vertical distance is less than or equal to the predetermined perpendicular error range.

24. The method of claim 20, wherein the step (b) comprises:
determining whether the screen can be moved in the horizontal direction, wherein when the screen can be moved in the horizontal direction, moving the screen in the horizontal direction; and
determining whether the screen can be moved in the vertical direction, wherein when the screen can be moved in the vertical direction, moving the screen in the vertical direction.

25. The method of claim 20, wherein the step (b) comprises:
gradually rotating the screen in the horizontal direction when the horizontal distance is greater than the predetermined level error range, wherein the screen is rotated by one horizontal rotating scale each time; and
gradually rotating the screen in the vertical direction when the vertical distance is greater than the predetermined perpendicular error range, wherein the screen is rotated by one vertical rotating scale each time.

26. The method of claim 25, further comprising:
stopping rotating the screen in the horizontal direction when the horizontal distance is less than or equal to the predetermined level error range.

27. The method of claim 25, further comprising:
stopping rotating the screen in the vertical direction when the vertical distance is less than or equal to the predetermined perpendicular error range.

28. The method of claim 25, wherein the step (b) further comprises:
determining whether the screen can be rotated in the horizontal direction, wherein when the screen can be rotated in the horizontal direction, rotating the screen in the horizontal direction; and
determining whether the screen can be rotated in the vertical direction, wherein when the screen can be rotated in the vertical direction, rotating the screen in the vertical direction.
